(19) United States
(12) Patent Application Publication
(10) Pub. No.: US 2015/0173118 A1
(43) Pub. Date: Jun. 18, 2015

(54) FLEXIBLE EXTENDED SIGNALING

(71) Applicant: QUALCOMM Incorporated, San Diego, CA (US)

(72) Inventors: Aziz GHOLMIEH, San Diego, CA (US); Kiran PATIL, San Diego, CA (US); Shailesh MAHESHWARI, San Diego, CA (US); Srinivasan BALASUBRAMANIAN, San Diego, CA (US); Daniel AMERGA, San Diego, CA (US); Gang Andy XIAO, San Diego, CA (US)

(21) Appl. No.: 14/574,042

(22) Filed: Dec. 17, 2014

Related U.S. Application Data
(60) Provisional application No. 62/024,946, filed on Jul. 15, 2014.
(60) Provisional application No. 61/917,831, filed on Dec. 18, 2013.

(51) Int. Cl. H04W 76/02; H04W 36/00

(52) U.S. Cl. CPC H04W 76/025; H04W 36/0005

(57) ABSTRACT

Certain aspects of the present disclosure provide methods and apparatus for implementing extended signaling in wireless communications. An example method generally includes communicating with a second apparatus using one or more communications channels defined by a radio access technology (RAT) standard, and communicating with the second apparatus via extended signaling not defined by the RAT standard.

### CROSS REFERENCE TO RELATED APPLICATIONS

The present application claims benefit of U.S. Provisional Patent Application Ser. No. 61/917,831, filed Dec. 18, 2013 and entitled “Extended Signaling,” and U.S. Provisional Patent Application Ser. No. 62/024,946, filed Jul. 15, 2014 and entitled “Flexible Extended Signaling,” both of which are assigned to the assignee hereof and which are incorporated herein by reference in their entirety.

### TECHNICAL FIELD

Certain embodiments of the present disclosure generally relate to flexible extended signaling in wireless communication systems.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-single-out or a multiple-in-multiple-out (MIMO) system.

Wireless devices comprise user equipments (UEs) and remote devices. A UE is a device that operates under direct control by humans. Some examples of UEs include cellular phones, smart phones, personal digital assistants (PDAs), wireless modems, handheld devices, laptop computers, netbooks, etc. A remote device is a device that operates without being directly controlled by humans. Some examples of remote devices include sensors, meters, location tags, etc. A remote device may communicate with a base station, another remote device, or some other entity. Machine type communication (MTC) refers to communication involving at least one remote device on at least one end of the communication.

### SUMMARY

Certain aspects of the present disclosure provide a method for communicating by a first apparatus using extended signaling. The method generally includes communicating with a second apparatus using one or more communications channels defined by a radio access technology (RAT) standard and communicating with the second apparatus via extended signaling not defined by the RAT standard.

Certain aspects of the present disclosure provide a method of communicating by a first apparatus using extended signaling. The method generally includes discovering whether a second apparatus is capable of communicating via extended signaling not defined by the RAT standard, and if the second apparatus is capable of communicating via extended signaling, communicating with the second apparatus via extended signaling not defined by the RAT standard.

Certain aspects of the present disclosure also include various apparatuses and computer program products capable of performing the operations described above.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates a multiple access wireless communication system, according to aspects of the present disclosure.

FIG. 2 is a block diagram of a communication system, according to aspects of the present disclosure.

FIG. 3 illustrates an example frame structure, according to aspects of the present disclosure.

FIG. 4 illustrates an example subframe resource element mapping, according to aspects of the present disclosure.

FIG. 5 illustrates example operations that may be performed by a base station to communicate via extended signaling in accordance with an aspect of the present disclosure.

FIG. 6 illustrates example operations that may be performed by a user equipment to communicate via extended signaling in accordance with an aspect of the present disclosure.

FIG. 7 illustrates an example of an extended signaling message included in a message payload in accordance with an aspect of the present disclosure.

FIG. 8 illustrates examples of one or more extended signaling messages that may be included in a message payload in accordance with an aspect of the present disclosure.

FIG. 9 illustrates an example extended signaling message in accordance with an aspect of the present disclosure.

FIG. 10 illustrates an example uplink extended signaling message in accordance with an aspect of the present disclosure.

FIG. 11 illustrates an example downlink extended signaling message in accordance with an aspect of the present disclosure.

FIG. 12 illustrates an example handover to E-UTRA in accordance with an aspect of the present disclosure.

FIG. 13 illustrates an example successful mobility from E-UTRA in accordance with an aspect of the present disclosure.

FIG. 14 illustrates an example failed mobility from E-UTRA in accordance with an aspect of the present disclosure.

FIGS. 15A-15B illustrate an example data unit that may be used to carry an extended signaling message in accordance with an aspect of the present disclosure.

### DETAILED DESCRIPTION

According to certain aspects provided herein, techniques for extended signaling in wireless communications are provided. The extended signaling may allow for the implementation of features not defined by radio access technology (RAT) standard or features to be included in a later version of the RAT standard.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

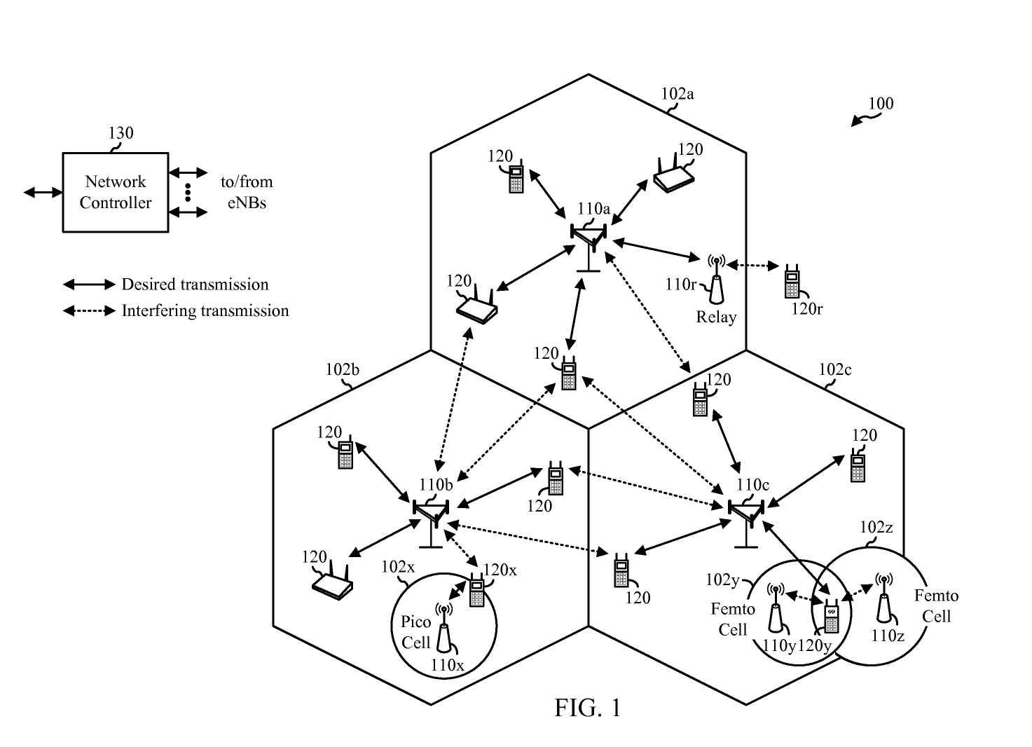

FIG. 1 shows a wireless communication network 100 in which aspects of the present disclosure may be practiced. For example, evolved Node Bs 110 and user equipments (UEs) 120 may communicate with each other using extended signaling as described herein.

Wireless communication network 100 may be an LTE network. The wireless network 100 may include a number of evolved Node Bs (eNBs) 110 and other network entities. An eNB may be a station that communicates with the UEs and may also be referred to as a base station, an access point, etc. A Node B is another example of a station that communicates with the UEs.

Each eNB 110 may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB. In the example shown in FIG. 1, the eNBs 110a, 110b and 110c may be macro eNBs for the macro cells 102a, 102b and 102c, respectively. The eNB 110x may be a pico eNB for a pico cell 102x. The eNBs 110y and 110z may be femto eNBs for the femto cells 102y and 102z, respectively. An eNB may support one or multiple (e.g., three) cells.

The wireless network 100 may also include relay stations. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 Watts) whereas pico eNBs, femto eNBs and relays may have a lower transmit power level (e.g., 1 Watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, etc. A UE may be able to communicate with macro eNBs, pico eNBs, femto eNBs, relays, etc. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal FFT size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

The wireless network 100 may also include UEs 120 capable of communicating with a core network via one or more radio access networks (RANs) that implement one or more radio access technologies (RATs). For example, according to certain aspects provided herein, the wireless network 100 may include co-located access points (APs) and/or base stations that provide communication through a first RAN implementing a first RAT and a second RAN implementing a second RAT. According to certain aspects, the first RAN may be a wide area wireless access network (WWAN) and the second RAN may be a wireless local area network (WLAN). Examples of WWAN may include, but not be limited to, for example, radio access technologies (RATs) such as LTE, UMTS, cdma2000, GSM, and the like. Examples of WLAN may include, but not be limited to, for example, RATs such as Wi-Fi or IEEE 802.11 based technologies, and the like.

According to certain aspects provided herein, the wireless network 100 may include co-located Wi-Fi access points (APs) and femto eNBs that provide communication through Wi-Fi and cellular radio links. As used herein, the term “co-located” generally means “in close proximity to,” and applies to Wi-Fi APs or femto eNBs within the same device enclosure or within separate devices that are in close proximity to each other. According to certain aspects of the present disclosure, as used herein, the term “femtoAP” may refer to a co-located Wi-Fi AP and femto eNB.

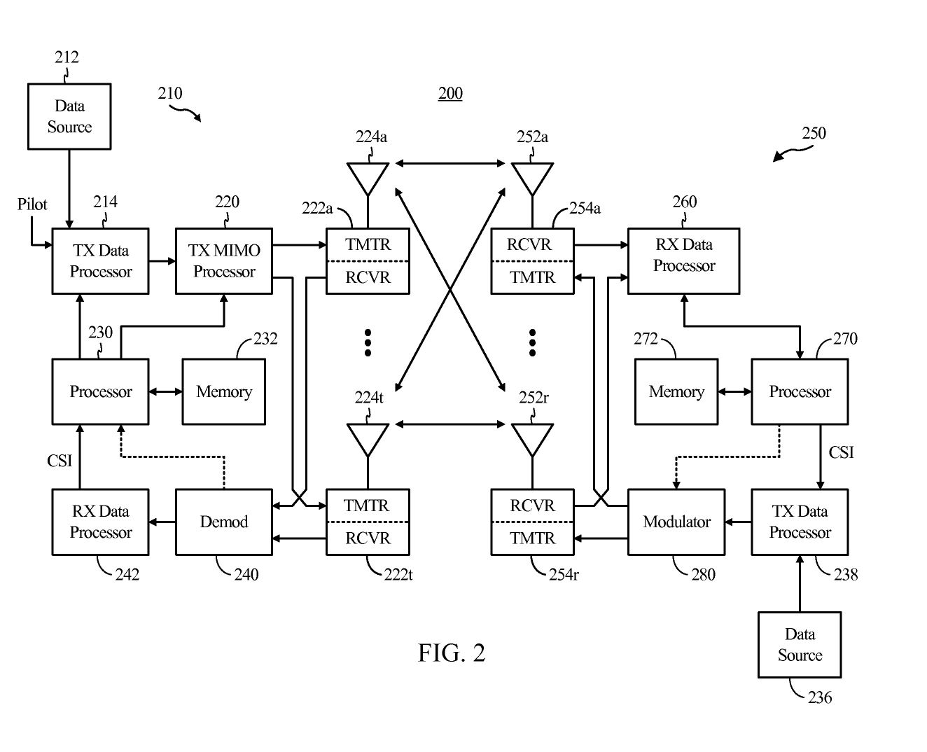

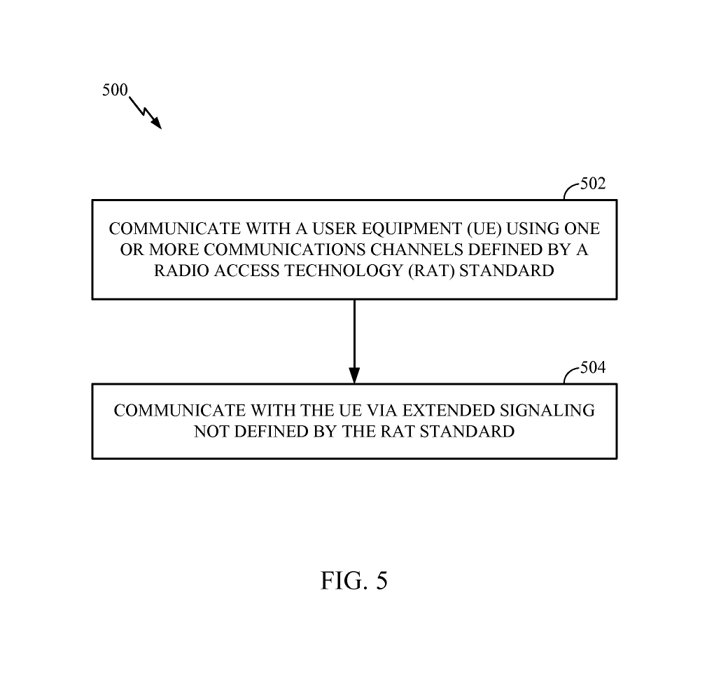

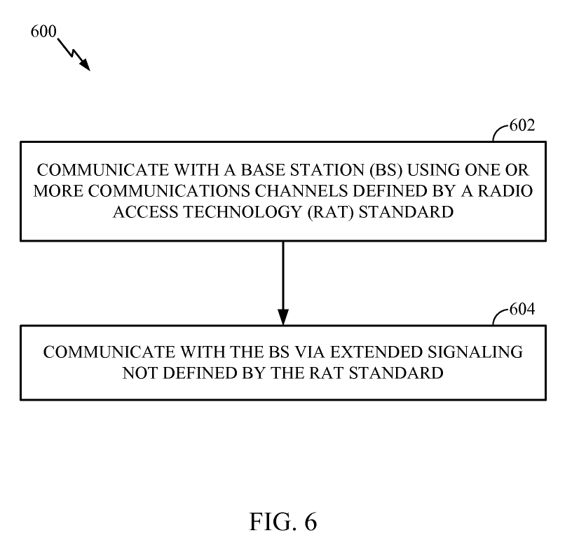

FIG. 2 is a block diagram of an embodiment of a transmitter system 210 (also known as an access point (AP)) and a receiver system 250 (also known as a user equipment (UE)) in a system, such as a MIMO system 200. Aspects of the present disclosure may practiced in the transmitter system (AP) 210 and the receiver system (UE) 250. For example, transmitter system 210 may be configured to communicate with a user equipment using one or more communications channels defined by a radio access technology (RAT) and using extended signaling not defined by the RAT standard, as described below with reference to FIG. 5. Receiver system 250 may be configured to communicate with a base station using one or more communications channels defined by a radio access technology (RAT) and using extended signaling not defined by the RAT standard, as described below with reference to FIG. 6.

At the transmitter system 210, traffic data for a number of data streams is provided from a data source 212 to a transmit (TX) data processor 214. In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r, and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use. Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights and then processes the extracted message.

According to certain aspects, the controllers/processors 230 and 270 may direct the operation at the transmitter system 210 and the receiver system 250, respectively. According to an aspect, the processor 230, TX data processor 214, and/or other processors and modules at the transmitter system 210 may perform or direct processes for the techniques described herein. According to another aspect, the processor 270, RX data processor 260, and/or other processors and modules at the receiver system 250 may perform or direct processes for the techniques described herein. For example, the processor 230, TX data processor 214, and/or other processors and modules at the transmitter system 210 may perform or direct operations 500 in FIG. 5. For example, the processor 270, RX data processor 260, and/or other processors and modules at the receiver system 250 may perform or direct operations 600 in FIG. 6.

In an aspect, logical channels are classified into Control Channels and Traffic Channels. Logical Control Channels comprise Broadcast Control Channel (BCCH), which is a DL channel for broadcasting system control information. Paging Control Channel (PCCH) is a DL channel that transfers paging information. Multicast Control Channel (MCCH) is a point-to-multipoint DL channel used for transmitting Multimedia Broadcast and Multicast Service (MBMS) scheduling and control information for one or several MTCHs. Generally, after establishing an RRC connection, this channel is only used by UEs that receive MBMS (Note: old MCCH+MSCH). Dedicated Control Channel (DCCH) is a point-to-point bi-directional channel that transmits dedicated control information used by UEs having an RRC connection. In an aspect, Logical Traffic Channels comprise a Dedicated Traffic Channel (DTCH), which is a point-to-point bi-directional channel, dedicated to one UE, for the transfer of user information. Also, a Multicast Traffic Channel (MTCH) is a point-to-multipoint DL channel for transmitting traffic data.

In an aspect, Transport Channels are classified into DL and UL. DL Transport Channels comprise a Broadcast Channel (BCH), Downlink Shared Data Channel (DL-SDCH), and a Paging Channel (PCH), the PCH for support of UE power saving (DRX cycle is indicated by the network to the UE), broadcasted over entire cell and mapped to PHY resources which can be used for other control/traffic channels. The UL Transport Channels comprise a Random Access Channel (RACH), a Request Channel (REQCH), an Uplink Shared Data Channel (UL-SDCH), and a plurality of PHY channels. The PHY channels comprise a set of DL channels and UL channels.

In an aspect, a channel structure is provided that preserves low PAPR (at any given time, the channel is contiguous or uniformly spaced in frequency) properties of a single carrier waveform.

For the purposes of the present document, the following abbreviations apply:
AM Acknowledged Mode
AMD Acknowledged Mode Data
ARQ Automatic Repeat Request
ASN.1 Abstract Syntax Notation
BCCH Broadcast Control CHannel
BCH Broadcast CHannel
C- Control-
CCCH Common Control CHannel
CCH Control CHannel
CCTrCH Coded Composite Transport Channel
CP Cyclic Prefix
CPT Control Protocol Data Unit Type
CRC Cyclic Redundancy Check
CTCH Common Traffic CHannel
DCCH Dedicated Control CHannel
DCH Dedicated CHannel
DL DownLink
DL-SCH DownLink Shared CHannel
DM-RS DeModulation-Reference Signal
DRB Data Radio Bearer
DSCH Downlink Shared CHannel
DTCH Dedicated Traffic Channel
E-UTRA Evolved Universal Terrestrial Radio Access
E-UTRAN Evolved Universal Terrestrial Radio Access Network
FACH Forward link Access CHannel
FDD Frequency Division Duplex
L1 Layer 1 (physical layer)
L2 Layer 2 (data link layer)
L3 Layer 3 (network layer)
LAC Location Area Code
LCID Logical Channel ID
LI Length Indicator
LSB Least Significant Bit
MAC Medium Access Control
MBMS Multimedia Broadcast Multicast Service
MCCH MBMS point-to-multipoint Control Channel
MME Mobility Management Entity
MRW Move Receiving Window
MSB Most Significant Bit
MSCH MBMS point-to-multipoint Scheduling CHannel
MTCH MBMS point-to-multipoint Traffic CHannel
PCCH Paging Control CHannel
PCH Paging CHannel
PDU Protocol Data Unit
PHY PHYsical layer
PhyCH Physical Channels
PLMN Public Land Mobile Network
RACH Random Access Channel
RAT Radio Access Technology
RB Resource Block
RLC Radio Link Control
RLC AM Radio Link Control Acknowledgement Mode
RRC Radio Resource Control
SAP Service Access Point
SDU Service Data Unit
SHCCH SHared channel Control CHannel
SN Sequence Number
SRB Signaling Radio Bearer
SUFI SUper FIeld
TCH Traffic CHannel
TDD Time Division Duplex
TFI Transport Format Indicator
TM Transparent Mode
TMD Transparent Mode Data
TTI Transmission Time Interval
U- User-
UE User Equipment
UL UpLink
UM Unacknowledged Mode
UMD Unacknowledged Mode Data
UMTS Universal Mobile Telecommunications System
UTRA UMTS Terrestrial Radio Access
UTRAN UMTS Terrestrial Radio Access Network
MBSFN Multimedia Broadcast Single Frequency Network
MCE MBMS Coordinating Entity
MCH Multicast CHannel
MSCH MBMS Control CHannel
PDCCH Physical Downlink Control Channel
PDCP Packet Data Convergence Protocol
PDSCH Physical Downlink Shared CHannel
PRB Physical Resource Block
VRB Virtual Resource Block

In addition, Re1-8 refers to Release 8 of the LTE standard.

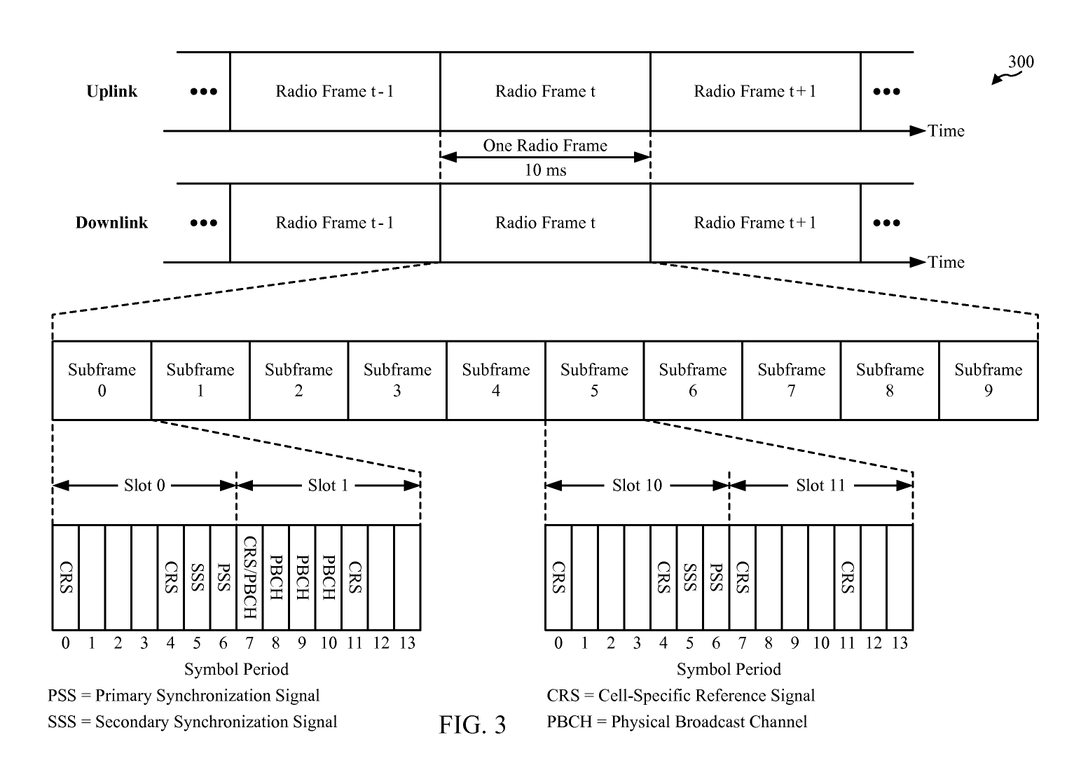

FIG. 3 shows an exemplary frame structure 300 for FDD in LTE. The transmission timeline for each of the downlink and uplink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., seven symbol periods for a normal cyclic prefix (as shown in FIG. 2) or six symbol periods for an extended cyclic prefix. The 2L symbol periods in each subframe may be assigned indices of 0 through 2L-1.

In LTE, an eNB may transmit a primary synchronization signal (PSS) and a secondary synchronization signal (SSS) on the downlink in the center 1.08 MHz of the system bandwidth for each cell supported by the eNB. The PSS and SSS may be transmitted in symbol periods 6 and 5, respectively, in subframes 0 and 5 of each radio frame with the normal cyclic prefix, as shown in FIG. 3. The PSS and SSS may be used by UEs for cell search and acquisition. During cell search and acquisition the terminal detects the cell frame timing and the physical-layer identity of the cell from which the terminal learns the start of the references-signal sequence (given by the frame timing) and the reference-signal sequence of the cell (given by the physical layer cell identity). The eNB may transmit a cell-specific reference signal (CRS) across the system bandwidth for each cell supported by the eNB. The CRS may be transmitted in certain symbol periods of each subframe and may be used by the UEs to perform channel estimation, channel quality measurement, and/or other functions. In aspects, different and/or additional reference signals may be employed. The eNB may also transmit a Physical Broadcast Channel (PBCH) in symbol periods 0 to 3 in slot 1 of certain radio frames. The PBCH may carry some system information. The eNB may transmit other system information such as System Information Blocks (SIBs) on a Physical Downlink Shared Channel (PDSCH) in certain subframes. The eNB may transmit control information/data on a Physical Downlink Control Channel (PDCCH) in the first B symbol periods of a subframe, where B may be configurable for each subframe. The eNB may transmit traffic data and/or other data on the PDSCH in the remaining symbol periods of each subframe.

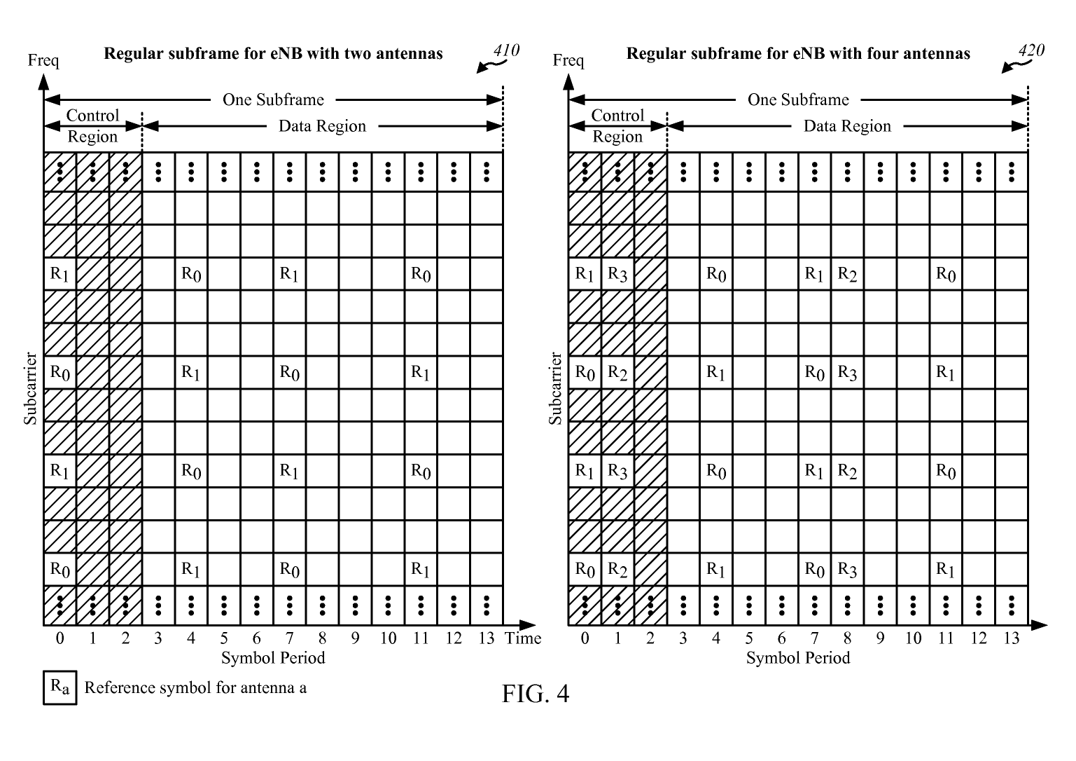

FIG. 4 shows two exemplary subframe formats 410 and 420 for the downlink with the normal cyclic prefix. The available time frequency resources for the downlink may be partitioned into resource blocks. Each resource block may cover 12 subcarriers in one slot and may include a number of resource elements. Each resource element may cover one subcarrier in one symbol period and may be used to send one modulation symbol, which may be a real or complex value.

Subframe format 410 may be used for an eNB equipped with two antennas. A CRS may be transmitted from antennas 0 and 1 in symbol periods 0, 4, 7 and 11. A reference signal is a signal that is known a priori by a transmitter and a receiver and may also be referred to as a pilot. A CRS is a reference signal that is specific for a cell, e.g., generated based on a cell identity (ID). In FIG. 4, for a given resource element with label Rₐ, a modulation symbol may be transmitted on that resource element from antenna a, and no modulation symbols may be transmitted on that resource element from other antennas. Subframe format 420 may be used for an eNB equipped with four antennas. A CRS may be transmitted from antennas 0 and 1 in symbol periods 0, 4, 7 and 11 and from antennas 2 and 3 in symbol periods 1 and 8. For both subframe formats 410 and 420, a CRS may be transmitted on evenly spaced subcarriers, which may be determined based on cell ID. Different eNBs may transmit their CRSs on the same or different subcarriers, depending on their cell IDs. For both subframe formats 410 and 420, resource elements not used for the CRS may be used to transmit data (e.g., traffic data, control data, and/or other data).

The PSS, SSS, CRS and PBCH in LTE are described in 3GPP TS 36.211, entitled “Evolved Universal Terrestrial Radio Access (E-UTRA); Physical Channels and Modulation,” which is publicly available.

An interlace structure may be used for each of the downlink and uplink for FDD in LTE. For example, Q interlaces with indices of 0 through Q-1 may be defined, where Q may be equal to 4, 6, 8, 10, or some other value. Each interlace may include subframes that are spaced apart by Q frames. In particular, interlace q may include subframes q, q+Q, q+2Q, etc., where q∈{0, . . . , Q-1}.

The wireless network may support hybrid automatic retransmission (HARQ) for data transmission on the downlink and uplink. For HARQ, a transmitter (e.g., an eNB) may send one or more transmissions of a packet until the packet is decoded correctly by a receiver (e.g., a UE) or some other termination condition is encountered. For synchronous HARQ, all transmissions of the packet may be sent in subframes of a single interlace. For asynchronous HARQ, each transmission of the packet may be sent in any subframe.

A UE may be located within the coverage area of multiple eNBs. One of these eNBs may be selected to serve the UE. The serving eNB may be selected based on various criteria such as received signal strength, received signal quality, pathloss, etc. Received signal quality may be quantified by a signal-to-noise-and-interference ratio (SINR), or a reference signal received quality (RSRQ), or some other metric. The UE may operate in a dominant interference scenario in which the UE may observe high interference from one or more interfering eNBs.

### Extended Signaling

Certain aspects of the present disclosure provide mechanisms for extended signaling, which may entail performing signaling not defined by a standard. This extended signaling may allow for the implementation and/or instruction of one or more new features before standards adoption. In this manner, the lengthy process of testing and/or formal adoption may be avoided. A network may utilize extended signaling when a new feature is to be supported.

Extended signaling may be forward and/or backward compatible on the base station side and/or the user equipment side. For example, an apparatus, such as an eNB supporting extended signaling, may communicate with one or more apparatus, such as UEs, that support extended signaling and/or UEs that are only standards compliant. Likewise, an apparatus, such as a UE, supporting extended signaling may communicate with one or more apparatus, such as eNBs, that support extended signaling and/or one or more apparatus, such as eNBs, that are only standards compliant.

In conjunction with extended signaling (e.g., signaling allowing for the implementation and/or instruction of new features), a framework to exchange extended signaling messages may be needed.

Implementations of extended signaling may be such that extended signaling causes minimal impacts to both UEs and eNBs. For UEs, extended signaling may be configured to have a minimal impact on, for example, power draw and battery life when extended signaling is not enabled. For eNBs, extended signaling may be configured to reduce and/or minimize the amount of processing required. Implementations may deal with conflicts caused by other extended signaling protocols by, for example, ignoring other extended signaling messages.

FIG. 5 illustrates example operations 500 that may be performed by a base station (BS) to communicate with a UE via extended signaling, in accordance with aspects of the present disclosure. The operations 500 may begin at 502, where a BS communicates with a user equipment using one or more communications channels defined by a radio access technology standard. At 504, the BS communicates with the UE via extended signaling not defined by the RAT standard.

FIG. 6 illustrates example operations 600 that may be performed by a UE to communicate with a BS via extended signaling. The operations 600 may begin at 602, where a UE communicates with a BS using one or more communications channels defined by a radio access technology standard. At 604, the UE communicates with the BS via extended signaling not defined by the RAT standard.

In an aspect, base stations and/or UEs may discover whether another device is capable of communicating via extended signaling. Communications via extended signaling may be performed only if the base station or UE discovers that the other entity is capable of communicating via extended signaling. In an aspect, the discovery phase may determine resources to be allocated for message processing.

In an aspect, discovery of extended signaling capability may entail receiving and detecting a message transmitted by another entity (e.g., network entity). The message may comprise a special signature. In an aspect, discovery may entail transmitting one or more extended signaling messages to another entity (e.g., network entity) and receiving a response to the one or more extended signaling messages. In an aspect, a base station may allocate resources for extended signaling after (e.g., only after) discovering that a UE is capable of communicating via extended signaling.

As briefly discussed above, discovery can entail transmitting one or more extended signaling messages to another entity (e.g., network entity) and receiving a response to the one or more extended signaling messages. In an aspect, the one or more extended signaling messages may be a broadcast message using a cyclic redundancy code (CRC) based on (e.g., colored by) an agreed sequence. In an aspect, the encoding and decoding process may be changed such that legacy devices would be unable to encode or decode the message. In an aspect, a network entity may broadcast a new message using an adjusted (e.g., malformed message). In aspects, one or more fields of the message may be repurposed. For example, a malformed message may comprise a malformed system information block. In an aspect, the one or more extended signaling messages may use (e.g., be implemented using) closed subscriber group (CSG) features. For example, a reserved CSG ID could be used by a macro base station to indicate that the base station supports enhanced signaling. In an aspect, a pre-agreed identification can be sent in a system identification block to indicate that a base station supports enhanced signaling.

An entity can respond to the one or more extended signaling messages. In an aspect, the entity can transmit a malformed message on the uplink. In an aspect, extended signaling can use the padding bits of a payload to transmit a special signature.

In an aspect, the discovery process may entail storing an identification of a network entity based on the discovery. A base station may store the identity of one or more UEs that support extended signaling, and/or a UE may store the identity of one or more base stations that support extended signaling. In an aspect, a UE may be configured with a set of PLMN and/or cell ID ranges identifying sets of base stations that support extended signaling. In an aspect, a UE could build a database of base stations and the extended signaling capability of each base station. A UE may be configured to perform a discovery request on one or more base stations that do not support extended signaling on a regular basis. In an aspect, a base station may maintain a list of one or more UEs that support extended signaling, based on, for example, an IMEI of a UE that supports extended signaling.

In an aspect, the discovery process can comprise communicating one or more non-standard messages using a radio link control (RLC) protocol. In an aspect, the messages can be communicated in RLC unacknowledged mode (UM). In an aspect, the messages can be communicated in RLC acknowledged mode (AM). In communicating messages in RLC AM, the one or more messages could be segmented (e.g., span a plurality of data units) to accommodate, for example, a limited amount of padding. Network entities may be configured to skip checking for acknowledgments in the discovery phase.

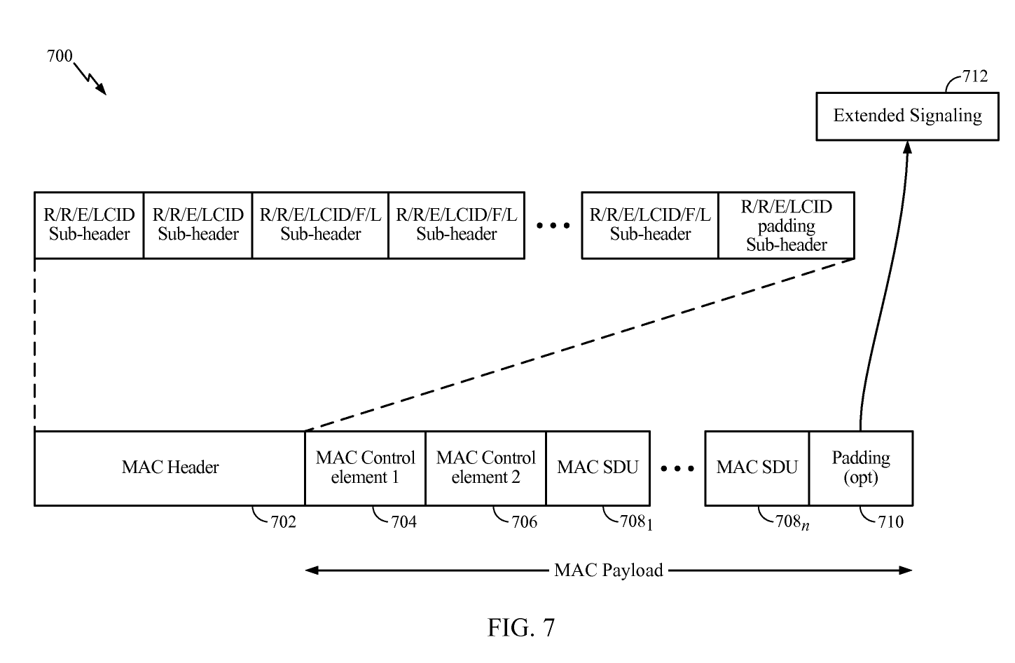

FIG. 7 illustrates an example MAC payload 700 in which extended signaling messages may be included, in accordance with an aspect of the present disclosure. As illustrated, a MAC layer data unit includes a MAC header 702 and a MAC payload in which extended signaling may be transmitted. The data unit may use a standard MAC header regardless of whether the data unit includes extended signaling. As illustrated, the MAC payload may include a first control element 704, a second control element 706, one or more MAC service data units (SDUs) 708, and padding 710. As shown, one or more extended signaling messages 712 can be transmitted using bits defined by a RAT standard as optional padding 710 bits of a MAC payload.

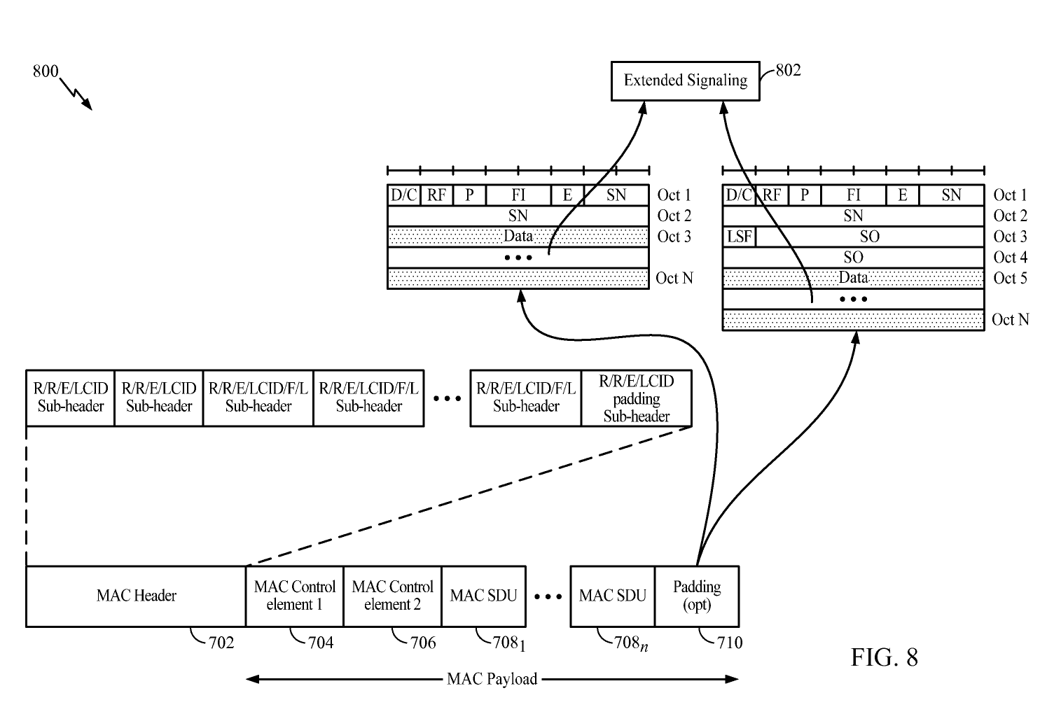

FIG. 8 illustrates an example MAC payload 800 in which extended signaling messages may be included to further support alternative protocols, in accordance with an aspect of the present disclosure. As described above, one or more extended signaling messages can be transmitted using bits defined by a RAT standard as padding bits 710 of a payload. As illustrated in FIG. 8, each extended signaling message 802 may include its own header and data. Including multiple extended signaling messages 802, each with its own header and data payload, may allow for backward and/or forward compatibility, avoid collisions with other extended signaling schemes, provide for reliable transmission and reception of extended signaling messages, and/or provide for the ability to fragment extended signaling messages in padding bits across multiple MAC payloads. In aspects, the one or more extended signaling messages may be AM or UM messages.

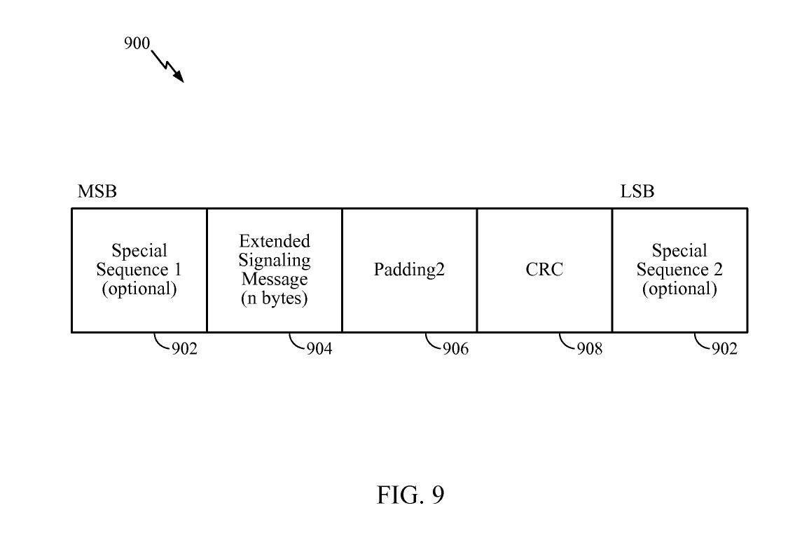

FIG. 9 illustrates an example message definition 900 for extended signaling in accordance with an aspect. In an aspect, extended signaling may have or be associated with one or more special sequences 902, the extended signaling message 904, padding 906, and/or a cyclic redundancy check 908. The one or more special sequences 902 are optional. A first special sequence may be used to indicate that a message (e.g., a subsequent message) is for extended signaling. Additionally or alternatively, a second special sequence may be used to indicate the end of an extended signaling message. In an aspect, cyclic redundancy check 908 can be used for the extended signaling message 904 (e.g., to ensure successful receipt of or to indicate that a message is an extended signaling message). For example, a network entity can check to determine if a CRC passes, and if so, the network entity can determine that the message is an extended signaling message. In an aspect, the CRC may be based on (e.g., may take into account) at least one of a UE identifier, a network identifier, or a system frame number by, for example, XOR-ing the CRC with a UE identifier, a network identifier, or a system frame number.

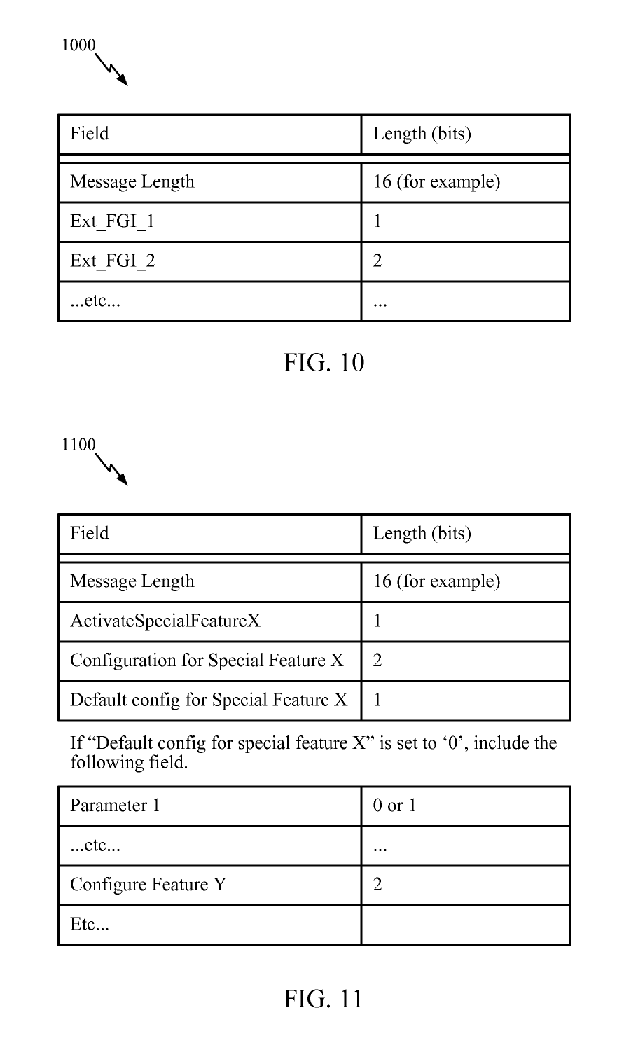

FIG. 10 illustrates an example uplink extended signaling message 1000 in accordance with an aspect. An uplink extended signaling message can include a message length field and/or one or more extended signaling fields.

FIG. 11 illustrates an example downlink extended signaling message 1100 in accordance with an aspect. A downlink extended signaling message field can include a message length field and/or one or more fields for each extended signaling message. For example, an extended signaling message can be used to indicate the presence of a non-standard feature, and/or may comprise a field indicating whether the non-standard feature is activated, a configuration, a default configuration, and/or one or more parameters for the non-standard feature.

In an aspect, extended signaling messages can be appended to the end of an RRC message. On the uplink, extended signaling can be included once a field indicating non-critical optional extensions is set to a value indicating that extensions are not included. Extended signaling messages may be then be decoded. In an aspect, a special sequence may note the beginning of an extended signaling message. Similar logic can be used for downlink extended signaling. In an aspect, extended signaling messages, may be transmitted on a new physical channel. In an aspect, extended signaling may be transmitted on a data radio bearer.

### Extended Signaling Framework

The extended signaling described above may help supplement signaling defined by a standard with the exchange of additional non-standard signaling between a mobile station and the network. As provided herein, such flexible signaling may be applied to multiple networks and multiple mobile stations using different protocols.

Certain aspects of the present disclosure also provide “procedures” for the non-standard signaling framework described above. An extended signaling framework may provide flexibility in implementing new functionality (e.g., by device and/or network vendors). This extended signaling, coupled with the extended procedures, may allow for the implementation and/or instruction of one or more new features before standards adoption.

According to certain aspects, extended signaling described above may be used to signal if a device (e.g., a UE, base station, and/or a network entity) is capable of supporting extended signaling and associated extended procedures. In such cases, once it is “discovered” that a device supports extended signaling and procedures, various extended (e.g., non-standard) procedures may be used in place of or in addition to standards-based procedures. In some cases, extended procedures may correspond to or be associated with standard procedures (e.g., add some additional feature). In other cases, extended procedures may be independent of standards-based procedures.

According to certain aspects, the signaling and procedures may be considered extensions of standard radio resource control (RRC) signaling. This extended RRC signaling and procedures may complement the standard RRC signaling and procedures. In an aspect, any standard message or procedure could be associated with an extended message to complement or replace (e.g., be used in lieu of) a standard message or procedure. The extended procedure could be run before, after, or instead of the standard procedure. Additional independent extended messages and procedures may also be defined.

The extended signaling and corresponding procedures may be considered an additional communications link (in addition to a standard link). In some cases, communication for one of the links may be encapsulated in the second link. For example, assuming a network operating with LTE and Wi-Fi, any uplink feedback for Wi-Fi communications can be carried over the LTE uplink. If LTE radio link control (RLC) is used for Wi-Fi, RLC Status reports may be tunneled in LTE. For example, the UE may use a reserved Control PDU (CPT) ID on the LTE RLC link to encapsulate the information regarding RLC reports of Wi-Fi (e.g., the use of the reserved CPT ID may help distinguish this information).

According to certain aspects, a standards-based connection may first be established before extended signaling is used. For example, an initial standard RRC connection setup may be performed before discovering if a device supports extended signaling. After the discovery operation, the extended signaling channel may be established via, for example, a pre-agreed hard coded scheme (e.g., MAC Padding, RRC Padding, or a reserved RLC LCID channel).

In some cases, a signaling channel may be established by configuring a new SRB using a special non-standard configuration. In an aspect, the signaling channel may be established by setting up a data radio bearer (DRB) as a signaling radio bearer (SRB), even though this may violate a standard ASN.1 configuration. This may be performed by not including the PDCP configuration for a DRB. In some cases, to reduce or minimize impact of the non-standard SRB on standard network traffic, this may be performed by using a different LCID derived from at least one of eps-BearerIdentity or DRB-Identity parameters or values. The derivation could use one or more operations like the addition, multiplication and/or the mod operators.

As noted above, an extended signaling channel may be established by tunneling messages, for example, using the DLInformationTransfer and ULInformationTransfer messages. This may be performed by re-using a container, such as the dedicatedInfoNAS, DedicatedInfoNAS, dedicatedInfoCDMA2000-1XRTT, DedicatedInfoCDMA2000, dedicatedInfoCDMA2000-HRPD, or DedicatedInfoCDMA2000 containers by using reserved fields and/or messages in the tunneled protocols.

In some cases, UE capability transfer (e.g., transfer of information indicating what features a UE supports) may be supplemented with additional non-standard capabilities. As an example, the UE could initiate the extended capability transfer without a network indication, avoiding additional signaling. If RLC AM fails to deliver the first message, the UE may abort the capability transfer procedure, but not the call. In an aspect, the network could save the extended UE capabilities. In this case, the UE might wait for the network to request such extended capabilities before sending them. By waiting for the network to request information about a UE's extended capabilities, the amount of overhead associated with UE capability transfer may be reduced.

In some cases, extended signaling may be applied to RRC connection procedures and/or configuration. For example, if it is discovered that a device supports extended signaling, additional UE configurations can be added based on the extended UE capabilities.

As another example, upon handover of the UE, an extended procedure may be aborted and the discovery and/or capability exchange procedures may be restarted. In an aspect, the extended procedures may also be aborted and the discovery and capability exchange procedures may be restarted if the network doesn't provide any additional configurations within some time (e.g., T minutes when the previous serving cell was capable of extended signaling).

In some cases, a UE may make decisions regarding whether to maintain or abort extended signaling or procedures based on certain conditions. For example, if a special SRB is configured for the non-standard signaling and the SRB is maintained upon a handover, extended procedures may be continued. As another example, if the SRB is removed upon a handover, the extended procedures on the new cell may be discontinued (e.g., aborted). Moreover, if the SRB was not configured on the source cell, the discovery procedure (e.g., including discovery regarding extended signaling) on the target cell may be initiated after the handover.

In some cases, various types of error handling may be applied to extend signaling. For example, if an extended procedure or decoding (e.g., of an ASN.1) of the extended message fails, the UE may abort the use of the extended signaling for the RRC connection. In some cases, the UE may ignore the failed message and continue using the extended signaling for the RRC connection.

In some cases, extended signaling may be used to define and/or configure physical layers. For example, extended signaling may be used to define and/or configure a non-standard LTE physical layer, a pre-standard physical layer, and/or non-LTE physical layers, such as Wi-Fi.

In some cases, extended signaling may be used to provide for flexible measurement procedures. For example, using extended signaling, a supported physical layer can be defined, configured and/or reported.

In some cases, extended signaling may be used support a request to release an RRC connection.

As noted above, a UE may make decisions regarding whether to maintain or abort extended signaling or procedures based on certain conditions. For example, upon occurrence of a radio link failure (RLF), the UE may: abort the use of the extended signaling on the cell, abort the use of the extended signaling on the LAC, abort the use of the extended signaling on the PLMN, and/or continue using the extended signaling on the cell, LAC and PLMN.

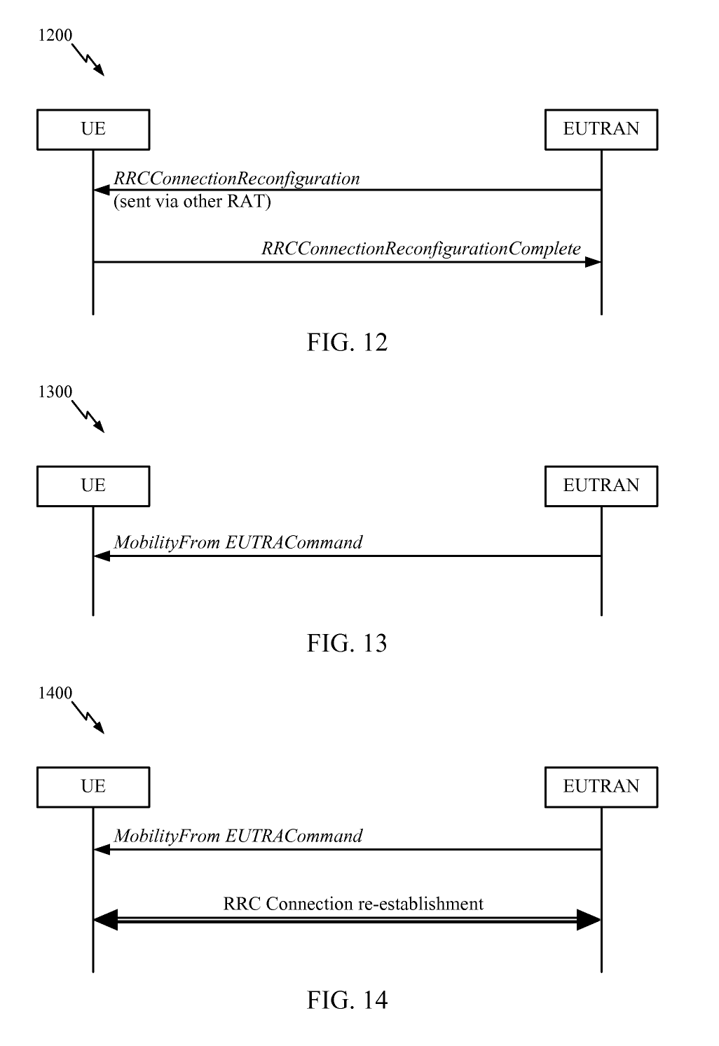

In some cases, upon handover (e.g., to E-UTRA), a UE may initiate the discover scheme by, for example, sending a special signature in the padding of a message sent on the uplink (e.g., on the RRC connection reconfiguration complete), as illustrated by message flow 1200 shown in FIG. 12. The UE may receive an RRC connection reconfiguration message (e.g., sent via the other RAT) and transmit an RRC connection reconfiguration complete message to the E-UTRAN.

If Mobility from E-UTRA is successful, as illustrated by message flow 1300 shown in FIG. 13, the UE may abort the extended procedures in the previous RAT, and potentially initiate a different set of extended procedures in the target RAT.

If Mobility from E-UTRA fails, as illustrated by message flow 1400 shown in FIG. 14, the UE may take various actions with regard to extended signaling. For example, the UE could abort the use of the extended signaling on the cell, abort the use of the extended signaling on the LAC, abort the use of the extended signaling on the PLMN, and/or continue using the extended signaling on the cell, LAC and PLMN. In aspects, extended signaling may be associated with an RRC connection reconfiguration without mobility during which additional UE configurations may be added based on extended UE capabilities.

In some cases, extended signaling may be used to effectively extend non-access stratum (NAS) signaling. For example, NAS signaling may also be exchanged using the extended signaling. In this case, the network side may have an enhanced network entity such as an MME, instead of an enhanced eNB, that knows how to interpret the extended NAS signaling.

In an aspect, additional signaling may be added for enhanced Multimedia Broadcast Multicast Services (eMBMS). For example, extended signaling may include signaling of services supported by each cell and in which frequency. In an aspect, an eMBMS service may be continued on a small cell (e.g., Wi-Fi, LTE or UMTS), for example, by using a dedicated bearer or IP multicast.

### Example Exteded Signaling Format

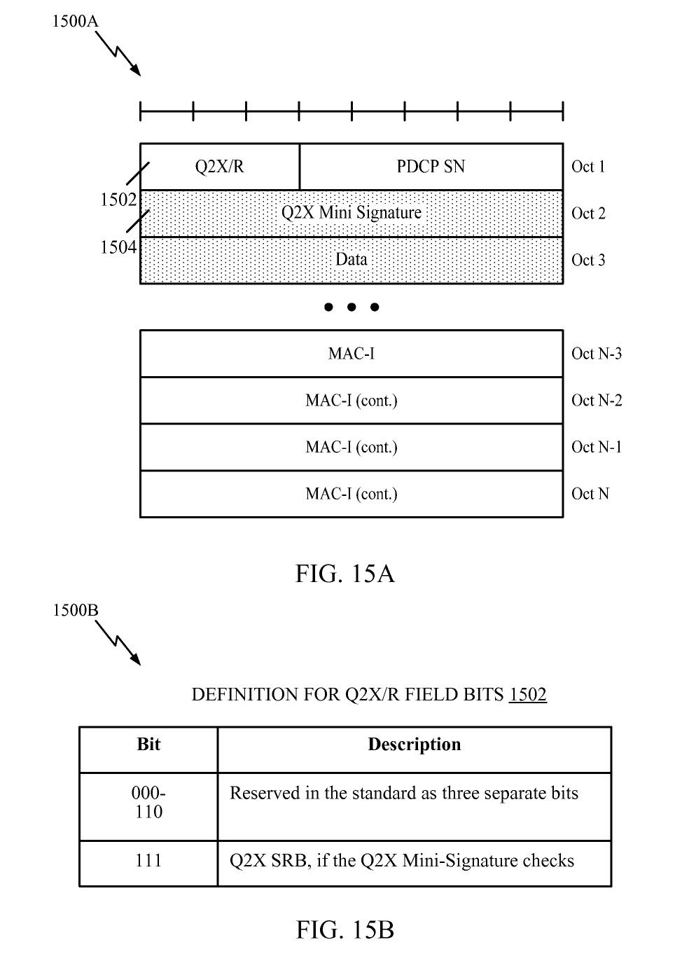

As described above, in aspects, devices may first perform discovery of extended signaling capability before actually communicating using extended signaling. In some cases, the discovery may involve receiving and detecting a message transmitted by another entity or apparatus indicating such capability. For example, the message may comprise a special signature (e.g., as shown in FIG. 15A described below), indicating extended signaling capability.

After the discovery phase described above, a BS and a UE can exchange extended signaling messages using, for example, a non-standard PDCP control protocol data unit (PDU). Extended signaling PDUs may be transmitted using the same RLC and RLC LCID channel as a standard SRB. Extended signaling PDUs may be integrity and cipher-protected using the same keys and sequence number space as that used for a particular SRB (e.g., SRB1).

Networks that support extended signaling may allocate a greater amount of resources to a UE than is needed for a UE to transmit during an RRC setup procedure. Outside of an initial message exchange, a UE can inform the network of the size of the UE's extended signaling. Extended signaling may be counted, for example, as part of a UE's signaling SRB.

In some cases, extended signaling SRBs may be radio bearers that are used specifically for the transmission of RRC and NAS messages. Various extended signaling SRBs may be defined. For example, a first extended signaling SRB (e.g., SRB0) may be used for RRC messages transmitted using the CCCH logical channel. A second extended signaling SRB (e.g., SRB1) may be used for RRC messages and NAS messages prior to the establishment of a third extended signaling SRB (e.g., SRB2). RRC messages carried on extended signaling SRB1 may include piggybacked NAS messages. Both extended signaling SRB1 and SRB2 may be transmitted on the DCCH logical channel. Extended signaling messages may be carried with standard RRC messages. Once security is activated, RRC messages carried on extended signaling SRB1, including messages comprising NAS or extended signaling, may be integrity protected and ciphered by PDCP.

FIG. 15A illustrates an example PDCP control PDU 1500 in which extended signaling may be carried, in accordance with aspects of the present disclosure.

As illustrated, in some aspects, the three bits 1502 (labeled Q2X/R) in the first octet designated as reserved bits may be used to signal that PDU 1500 includes extended signaling. The remaining five bits of the first octet may be used for a PDCP sequence number (PDCP SN).

In some aspects, as noted above, PDU 1500 may further include an extended signaling mini signature 1504, which indicates whether PDU 1500 includes extended signaling. The extended signaling mini signature may be used as an additional check if a bit pattern used for the reserved bits is also used for another purpose (e.g., as defined by a standard) that may result in confusion as to whether the PDU 1500 is carrying extended signaling. The extended signaling mini signature may comprise eight bits. In some cases, the extended signaling mini signature may be the bitwise complement of the PDCP sequence number and a predefined bit pattern. Data octets may be included after the extended signaling mini signature, and a message authentication check (e.g., a MAC-I) may be included at the end of PDU 1500.

FIG. 15B shows example definitions for different values of the three bits 1502 of the reserved/extended signaling field shown in FIG. 15A. As illustrated, in aspects, bit patterns 000 through 110 may be reserved in the standard for other purposes. If bits 1502 are set to any one of these reserved bit patterns, it may be determined that data unit 1500 does not include extended signaling.

However, in aspects, if bits 1502 are set to 111, the data unit may be a signaling radio bearer (SRB) that includes an extended signaling message. In some cases, a determination that data unit 1500 includes extended signaling may be further based on whether the extended signaling mini signature 1504 passes a check. For example, the extended signaling mini signature 1504 may be used if all values for the three reserved bits are later defined by a standard (e.g., that bit pattern 111 is used for purposes other than indicating that data unit 1500 includes extended signaling).

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method of wireless communications by a first apparatus, comprising:
communicating with a second apparatus using one or more communications channels defined by a radio access technology (RAT) standard; and
communicating with the second apparatus via extended signaling not defined by the RAT standard.

2. The method of claim 1, wherein communicating with the second apparatus via extended signaling comprises at least one of:
communicating using one or more extended messages not defined by the RAT standard, wherein the one or more extended messages are associated with one or more standard messages defined by the RAT standard and used in addition to or in lieu of the associated one or more standard messages;
communicating using one or more extended messages not associated with associated standard messages defined by the RAT standard; or
communicating using one or more extended procedures, wherein the one or more extended procedures are associated with one or more standard procedures defined by the RAT standard and used in addition to or in lieu of the associated one or more standard procedures.

3. The method of claim 2, wherein communicating using one or more extended messages in addition to the associated one or more standard messages comprises encapsulating the one or more extended messages in the one or more standard messages.

4. The method of claim 1, wherein communicating with the second apparatus via extended signaling comprises:
encapsulating data regarding a first RAT, in a message sent on a second RAT associated with the RAT standard.

5. The method of claim 1, further comprising:
continuing communications via extended signaling, if a Signal Radio Bearer (SRB) is maintained after a handover of the UE to another apparatus.

6. The method of claim 1, wherein:
communicating with the second apparatus via extended signaling not defined by the RAT standard includes sending an extended capability message indicating a capability of the first apparatus to use extended features, the extended capability message associated with a capability transfer message.

7. The method of claim 1, wherein communicating with the second apparatus via extended signaling comprises at least one of:
aborting communicating via extended signaling upon handover of the first apparatus to another second apparatus;
at least one of aborting communicating via extended signaling or continuing communicating via extended signaling, for an RRC connection, upon failure to perform an extended procedure; or
performing extended measurement reporting not defined by the RAT standard.

8. The method of claim 1, further comprising:
detecting a failure event; and
aborting communicating via extended signaling in at least a cell on which the failure event was detected, in response to detecting the failure event.

9. The method of claim 1, further comprising:
detecting a failed handover from a source RAT to a target RAT; and
continuing to communicate via extended signaling in at least a cell in which the failed handover was detected after detecting the failed handover.

10. The method of claim 9, further comprising:
aborting communicating via extended signaling in at least one of a local area code (LAC) of a public land mobile network (PLMN) or the PLMN, in response to detecting failed handover.

11. The method of claim 1, wherein communicating with the second apparatus via extended signaling comprises:
communicating using extended non-access stratum (NAS) signaling not defined by the RAT standard or extended Multimedia Broadcast Multicast Services (MBMS) signaling not defined by the RAT standard.

12. The method of claim 1, wherein the communicating with the second apparatus via extended signaling utilizes one or more bits defined by the RAT standard as padding bits of a payload.

13. The method of claim 1, wherein the communicating with the second apparatus via extended signaling utilizes one or more messages with one or more special sequences indicating that the message is for extended signaling.

14. The method of claim 1, wherein the communicating with the second apparatus via extended signaling utilizes one or more messages with a cyclic redundancy check.

15. The method of claim 1, wherein the communicating with the second apparatus via extended signaling includes:
utilizing extended signaling bits appended to an end of a radio resource control (RRC) message.

16. The method of claim 1, further comprising performing at least one of logical channel prioritization based on the extended signaling or buffer status reporting based on the extended signaling.

17. A method of wireless communications by a first apparatus, comprising:
discovering whether a second apparatus is capable of communicating via extended signaling not defined by a radio access technology (RAT) standard; and
if the second apparatus is capable of communicating via extended signaling, communicating with the second apparatus via extended signaling not defined by the RAT standard.

18. The method of claim 17, wherein the discovering comprises detecting a message transmitted by the second apparatus with a special signature.

19. The method of claim 17, wherein the discovering comprises:
transmitting one or more extended signaling messages; and
receiving, from the second apparatus, a response to the one or more extended signaling messages.

20. The method of claim 17, wherein the discovering comprises:
receiving one or more extended signaling messages from the second apparatus; and
transmitting, to the second apparatus, a response to the one or more extended signaling messages.

21. A first apparatus for wireless communications, comprising:
means for communicating with a second apparatus using one or more communications channels defined by a radio access technology (RAT) standard; and
means for communicating with the second apparatus via extended signaling not defined by the RAT standard.

22. The first apparatus of claim 21, wherein the means for communicating with the second apparatus via extended signaling comprises at least one of:
means for communicating using one or more extended messages not defined by the RAT standard, wherein the one or more extended messages are associated with one or more standard messages defined by the RAT standard and used in addition to or in lieu of the associated one or more standard messages;
means for communicating using one or more extended messages not associated with associated standard messages defined by the RAT standard; or
means for communicating using one or more extended procedures, wherein the one or more extended procedures are associated with one or more standard procedures defined by the RAT standard and used in addition to or in lieu of the associated one or more standard procedures.

23. The first apparatus of claim 22, wherein the communicating using one or more extended messages in addition to the associated one or more standard messages comprises encapsulating the one or more extended messages in the one or more standard messages.

24. The first apparatus of claim 21, wherein the means for communicating with the second apparatus via extended signaling comprises:
means for encapsulating data regarding a first RAT, in a message sent on a second RAT associated with the RAT standard.

25. The first apparatus of claim 21, further comprising:
means for continuing communications via extended signaling, if a Signal Radio Bearer (SRB) is maintained after a handover of the UE to another apparatus.

26. The first apparatus of claim 21, wherein:
means for communicating with the second apparatus via extended signaling not defined by the RAT standard includes means for sending an extended capability message indicating a capability of the first apparatus to use extended features, the extended capability message associated with a capability transfer message.

27. The first apparatus of claim 21, wherein the means for communicating with the second apparatus via extended signaling comprises at least one of:
means for aborting communicating via extended signaling upon handover of the first apparatus to another second apparatus;
means for at least one of aborting communicating via extended signaling or continuing communicating via extended signaling, for an RRC connection, upon failure to perform an extended procedure; or
means for performing extended measurement reporting not defined by the RAT standard.

28. The first apparatus of claim 21, further comprising:
means for detecting a failure event; and
means for aborting communicating via extended signaling in at least a cell on which the failure event was detected, in response to detecting the failure event.

29. The first apparatus of claim 21, further comprising:
means for detecting a failed handover from a source RAT to a target RAT; and
means for continuing to communicate via extended signaling in at least a cell in which the failed handover was detected after detecting the failed handover.

30. The first apparatus of claim 29, further comprising:
means for aborting communicating via extended signaling in at least one of a local area code (LAC) of a public land mobile network (PLMN) or the PLMN, in response to detecting failed handover.

31. The first apparatus of claim 21, wherein the means for communicating with the second apparatus via extended signaling comprises:
means for communicating using extended non-access stratum (NAS) signaling not defined by the RAT standard or extended Multimedia Broadcast Multicast Services (MBMS) signaling not defined by the RAT standard.

32. The first apparatus of claim 21, wherein the means for communicating with the second apparatus via extended signaling utilizes one or more bits defined by the RAT standard as padding bits of a payload.

33. The first apparatus of claim 21, wherein the means for communicating with the second apparatus via extended signaling utilizes one or more messages with one or more special sequences indicating that the message is for extended signaling.

34. The first apparatus of claim 21, wherein the means for communicating with the second apparatus via extended signaling utilizes one or more messages with a cyclic redundancy check.

35. The first apparatus of claim 21, wherein the means for communicating with the second apparatus via extended signaling includes:
means for utilizing extended signaling bits appended to an end of a radio resource control (RRC) message.

36. The first apparatus of claim 21, further comprising means for performing at least one of logical channel prioritization based on the extended signaling or buffer status reporting based on the extended signaling.

37. A first apparatus of wireless communications by a first apparatus, comprising:
means for discovering whether a second apparatus is capable of communicating via extended signaling not defined by a radio access technology (RAT) standard; and
means for, if the second apparatus is capable of communicating via extended signaling, communicating with the second apparatus via extended signaling not defined by the RAT standard.

38. The first apparatus of claim 37, wherein the means for discovering comprises means for detecting a message transmitted by the second apparatus with a special signature.

39. The first apparatus of claim 37, wherein the means for discovering comprises:
means for transmitting one or more extended signaling messages; and
means for receiving, from the second apparatus, a response to the one or more extended signaling messages.

40. The first apparatus of claim 37, wherein the means for discovering comprises:
means for receiving one or more extended signaling messages from the second apparatus; and
means for transmitting, to the second apparatus, a response to the one or more extended signaling messages.
